(19) United States
(12) Patent Application Publication
(10) Pub. No.: US 2024/0173110 A1
(43) Pub. Date: May 30, 2024

(54) DENTAL PROCESSING PIECE

(71) Applicant: Heinrich STEGER, Sand in Taufers (IT)

(72) Inventor: Heinrich STEGER, Sand in Taufers (IT)

(21) Appl. No.: 18/517,449

(22) Filed: Nov. 22, 2023

(30) Foreign Application Priority Data
Nov. 25, 2022 (EP) 22209641.4

(51) Int. Cl. A61C 13/00

(52) U.S. Cl. CPC A61C 13/0022; A61C 13/0006

(57) ABSTRACT

The invention relates to a dental piece being processed (1) or blank for producing a dental restoration, in particular an abutment, crown, bridge or snap-on connection, having a processing area (B), which may be processed by a dental processing device (2) and which has a cylindrical base body having a longitudinal axis (X), a top surface (5), a base surface (6) and a lateral surface (7), and a fastening area (F) for fastening the piece being processed (1) to a holder (3) of the processing device (2), wherein the fastening area (F) is arranged radially around the cylindrical base body of the processing area (B), wherein the piece being processed (1) may be mounted in the holder (3) with the aid of the fastening area (F) in such a way that it may be processed in parallel to the longitudinal axis (X) in the mounted state.

The invention relates to a dental processing piece or a blank for producing a dental restoration, in particular an abutment, crown, bridge, or snap-on connection, having a processing area, which may be processed by a dental processing device and which has a cylindrical base body having a longitudinal axis, a top surface, a base surface and a lateral surface, and a fastening area for fastening the piece being processed to a holder of the processing device. The invention furthermore relates to a holder for holding a dental piece being processed, a set having at least one such piece being processed and such a holder and a dental processing device.

### BACKGROUND OF THE INVENTION

In the dental industry, a wide variety of parts that form a dental prosthesis have to be manufactured. With the help of processing devices such as CNC devices, which have processing heads for milling or grinding, there may be manufactured from dental pieces being processed, i.e. dental blanks, having standardized geometries, differently shaped abutments, crowns, bridges and the like.

Processing the dental blanks is usually realized using very expensive industrial machine tools, requiring considerable labour effort. The abutments manufactured must have a wide variety of shapes customized to the patient and be straight or angled, for example.

A dental piece being processed including holder is disclosed, for example, in the DE 20 2014 103 291 U1. Processing the piece being processed is realized in the processing machine at right angles to the longitudinal axis of the dental piece being processed.

The DE 102014015423A1 discloses a blank, which consists of the actual blank material along the longitudinal axis of the blank, an element for the connection geometry for the dental component to be manufactured from the blank, and an enclosing frame. The enclosing frame is thus configured to enclose the holder on the milling machine, thereby placing the blank also perpendicular to the processing device.

A blank disclosed in EP 2754408 A2 comprises at least one engagement element, which extends in the form of a rib or groove along the body of the blank. Using a holding element, which is configured accordingly, the blank may be fastened to a holding device by engaging longitudinally into the rib or groove. After processing the blank, a more detailed post-processing is required as the areas below the holding device during processing are not freely accessible.

US 20030073394A1 discloses a two-part blank, whose milling section and supporting section, with a shaft for fastening in a milling machine, are interconnected and connected by a projection on the base side of the milling section and a recess on the supporting section.

The holding device disclosed in WO 2015022296 A1 comprises a clamping device or locking device, in which the piece being processed is enclosed by a clamping jaw.

In summary, all blanks or holding systems, respectively, in the cited documents are based to the same problem. All blanks disclosed are designed to be processed perpendicular to their longitudinal axis. This is due to the arrangement of the area corresponding to the intended holder. Therefore, it is not possible to mill specifically adjusted threads into the piece being processed to enable also differently angled abutments having various form-fitting connections such as, for example, a screw connection. Additionally, it is not possible to reposition the piece being processed multiple times, i.e., to clamp and unclamp, and to process it once or multiple times, individually or as an assembly in connection with other elements, such as a cover screw, ceramic veneers, surface treatments, etc., as the holding systems operate with frictionally engaged connections.

### SUMMARY OF THE INVENTION

The invention is therefore based on the task of providing a dental processing piece processed and a holder, which make it possible to manufacture components for dental prostheses extremely precisely and accurately, even using smaller machine tools, and which may be customized to the patient in a very simple manner.

This task is solved by a dental piece being processed/dental processing piece or a blank for producing a dental restoration, in particular an abutment, crown, bridge, or snap-on connection, with a processing area, which may be processed by a dental processing device and which has a cylindrical base body having a longitudinal axis, a top surface, a base surface, and a lateral surface, and a fastening area for fastening the piece being processed to a holder of the processing device, wherein the fastening area is arranged around the cylindrical base body of the processing area. The blank may be mounted in the holder with the aid of the fastening area in such a way that it may be processed in parallel to the longitudinal axis in the mounted state. By processing in parallel to the longitudinal axis of the piece being processed this may be processed extremely flexibly, and various form-fit connections, such as threaded bores and the like, may also be drilled into the piece being processed. Due to the arrangement of the fastening area around a section of the processing area in accordance with the invention, the processing area may also be processed on the end face over the entire area. By mounting the blank on the fixing area in the holder, the area below the fixing area, around which the fixing area is arranged, may also be processed when processing in parallel to the longitudinal axis. For example, there may be provided on finished dental prosthesis part ridges that connect the dental prosthesis part to the fastening area, which are removed from the dental prosthesis part in a final step.

However, it is also possible to position the blank by way of various intermediate adapters at various adjustable angles to the processing device.

By processing in parallel to the longitudinal axis in combination with radial fastening, there may be introduced any parallel and transverse bores on the blank in the fastening area up to an angle that is limited by the processing device. In contrast, with blanks that are being processed at right angles to the longitudinal axis, the angle of the bores is limited to 30° and there may not be processed any form-fit connections. As the blank is not clamped at the end face but rather radially at the fastening area, the blank may be processed on the top surface from all sides as often as required. This means that the workpiece may be repositioned several times, e.g. clamped and unclamped, and also processed once or several times, individually or as an assembly in connection with other elements, such as a cover screw, ceramic veneers, surface treatments, etc.

The piece being processed or blank may also be a semi-finished product. In the following, the terms piece being processed and blank are used synonymously.

The dental restoration that may be produced from the blank may be any type of dental restoration and structure. The embodiment of the blank according to the invention makes it possible to manufacture any dental restoration therefrom.

The height of the fixing area may be smaller than the height of the processing area or the same. If the height of the fixing area is smaller, less material needs to be removed during processing, which is why processing may be carried out more quickly and efficiently.

Particularly preferably, the fastening area has at least one lateral holding surface, which is configured as an indentation, on which the clamping elements of the holder will press in the mounted state. This means that the dental piece being processed may be clamped in the holder using the fastening area. The lateral holding surfaces determine the orientation of the piece being processed within the holder. With the help of the clamping elements, the piece being processed may be mounted in the holder in a very simple way with repeatable accuracy and reproducibility. For example, the blank may be fastened using high-precision three-point clamping elements.

Furthermore, the fastening area may be configured in the shape of a ring around a section of the lateral surface of the piece being processed. In this way, the piece being processed may be fastened to the holder in a very simple manner, for example by using a holding ring to clamp the fastening area to the holder.

The piece being processed may also have a pre-milled internal channel.

In a further embodiment variant, the lateral surface of the processing area and/or the surface of the fastening area is at least partially circular cylindrical in shape, with the lateral diameter of the fastening area being larger than the lateral diameter of the processing area. In this way, the fastening area is the widest area of the piece being processed and this may be clamped into a holder at the fastening area. Due to the circular cross-section, on the one hand, the piece being processed may be clamped to the holder very easily, for example with the aid of a holding ring, and, on the other hand, the processing area may be processed very flexibly without a basic shape being specified. In particular, an angled abutment or the like may be produced.

The ratio of the lateral diameter of the fastening area to the lateral diameter of the processing area is particularly preferable such that, on the one hand, the lateral diameter of the processing area is not too large, such that the cycle time during processing is not extended and the blank cannot be processed efficiently, as a large amount of material must first be removed. On the other hand, the lateral diameter of the processing area must be chosen to be large enough to accommodate a plurality of different dental structures and allow these to be produced from the blank. The diameter of the fastening area must be chosen to be large enough to ensure that the largest processing tool used in the processing device still has sufficient space to process the processing area. If the diameter is too small, the processing tool may not be able to reach below the fastening area without removing the fastening area.

The dental piece being processed may also assume any other cylindrical shape and have a polygonal base surface. In addition, the fastening area may also be arranged only partially around the processing area.

Furthermore, the blank, preferably at the end facing the fastening area, may have a prefabricated implant connection for fixing the piece being processed to a dental implant. This may make work easier for dental technicians. The implant connection may have a different shape depending on the area of application and the type of dental implant used. It is particularly preferable for the fastening area to be situated in the longitudinal direction of the piece being processed directly above the implant connection, i.e. above the base surface of the processing area. The fastening area may then extend across a height that extends from the base surface of the processing area to at most half the height of the processing area. In this way, the dental piece being processed may be processed very flexibly and from all sides by a processing device from the top surface, i.e. from the side opposite to the implant connection.

Particularly preferably, the piece being processed has a length of the piece being processed length along the longitudinal axis that extends over the entire length of the piece being processed. This means that the height of the processing area corresponds to the entire length of the piece being processed. Processing along the entire piece being processed is possible due to the processing of the piece being processed in parallel to the longitudinal axis. By fastening the piece being processed in the holder to the fastening area, which is arranged radially around the longitudinal axis, the area below the fastening area may also be processed. Nevertheless, a precise and accurately aligned fixation of the piece being processed in the processing device is being guaranteed.

There may further be provided that the fastening area and the processing area of the piece being processed are configured as an integral part. In this way, the piece being processed only forms a single block, which consists of one material.

Preferably, the piece being processed is made of a dental alloy such as a titanium alloy or a cobalt-chromium alloy.

In addition, the invention also relates to a holder for holding a dental piece being processed or a blank, with a holding area for the dental piece being processed or the blank, wherein a clamping device is configured in the holding area, wherein in the state of the piece being processed mounted on the holder, the clamping device clamps around a fastening area formed on the piece being processed radially around its longitudinal axis.

Preferably, the clamping device comprises at least one clamping element. The clamping element may be used to clamp the fastening area formed radially around an area of the blank in the holder. For this purpose, the clamping element engages in a lateral holding surface on the fastening area in the state of the piece being processed being mounted on the holder.

The clamping device particularly preferably comprises a holding ring, wherein the holding ring clamps the fastening area in the state of the piece being processed being mounted on the holder. With the aid of the holding ring, the piece being processed may be fixed to the holder very easily, precisely and with little vibration.

The clamping device may in addition comprise a clamping element that may move in at least two axes.

In a further embodiment variant, the holder has at least two holding areas for holding respectively one dental piece being processed.

The invention also relates to a set with least one piece being processed according to the invention and a holder according to the invention.

The invention further relates to a dental processing device with a housing, at least one holder according to the invention connected to the housing, in particular movably, at least one dental piece being processed according to the invention, which may be fastened or is fastened in the holder, and at least one processing head, in particular a milling cutter, grinder or the like, for processing the piece being processed.

Furthermore, the processing device may have a calibration device, whereby the position of the at least one piece being processed relative to the holder may be determined by the calibration device.

Preferably, the processing device comprises a control or regulating unit, by means of which the processing head, a movement of the holder and/or the calibration device may be controlled or regulated.

### BRIEF DESCRIPTION OF THE DRAWINGS

FIG. 1a to 1g illustrate various views of a piece being processed,

FIGS. 2a to 2d illustrate various views of a holder together with pieces being processed,

FIG. 3 shows a cut-out of a dental processing device with inserted holder and pieces being processed, and

FIGS. 4a to 4b show a piece being processed in the form of a dental construction.

### DETAILED DESCRIPTION OF THE INVENTION

Further advantages and details of the invention are explained below with reference to the figures and figure descriptions.

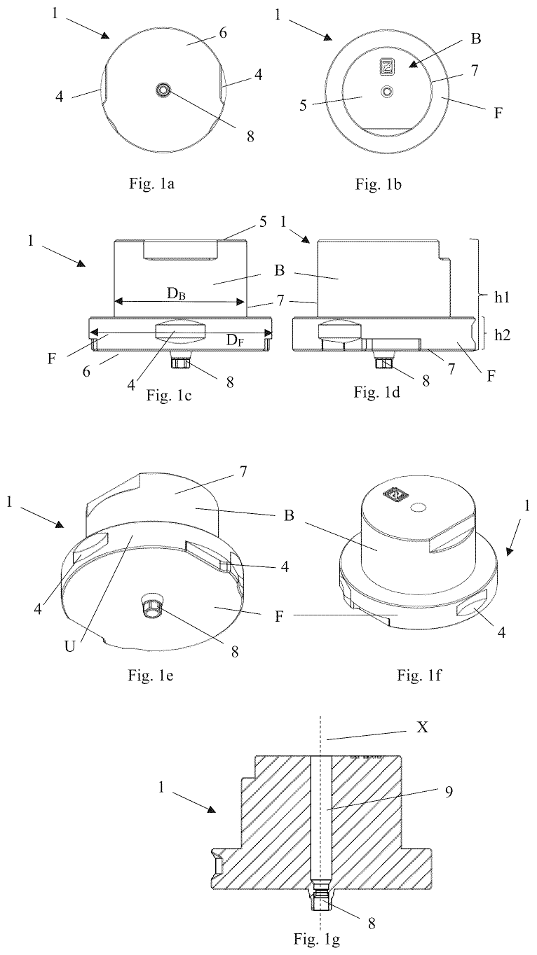

FIGS. 1a to 1g show a dental piece being processed 1 or a blank in the form of an abutment from below (FIG. 1a), from above (FIG. 1b), from the side (FIGS. 1c and 1d), in perspective view (FIGS. 1e and 1f) and in a sectional view (FIG. 1g).

As shown in FIGS. 1a to 1g, the dental piece being processed 1 comprises a processing area B, which may be processed by a dental processing device 2 and which has a cylindrical base body having a top surface 5, a base surface 6 and a lateral surface 7. In addition, the piece being processed 1 comprises a fastening area F for fastening the piece being processed 1 to a holder 3 of the processing device 2. The fastening area F is arranged around the cylindrical base body of the processing area B in such a way that the height h2 of the fastening area F is less than the height h1 of the processing area B. With the aid of the fastening area F, the piece being processed 1 may be mounted in the holder 3 in such a way that it may be processed in parallel to the longitudinal axis X in the mounted state.

Preferably, the dental piece being processed is made of a dental alloy such as titanium alloys or a cobalt-chrome alloy.

In addition, the fastening area B may have at least one lateral holding surface 4, which is configured as indentations, on which clamping elements 4′ of the holder 3 will press in the mounted state. The clamping elements 4′ may engage in these lateral holding surfaces 4 and thus prevent the piece being processed 1 from moving within the holder 3. Preferably, the lateral holding surfaces 4 are configured as indentations as shown in FIGS. 1a-1g.

As may be seen in FIG. 1e, the majority of the outer contour of the dental piece being processed 1 is preferably rotationally symmetrical about the longitudinal axis X. Only the lateral holding surfaces 4 and possibly the implant connection 8 are not rotationally symmetrical.

As shown in FIGS. 1c and 1d, the implant connection 8 is preferably situated at the end of the piece being processed 1 facing the fastening area F or on the base surface 6 of the processing area B, respectively, and is used to fix the piece being processed 1 to a dental implant. The dental piece being processed 1 may therefore already be provided with a prefabricated implant connection 8, which may also vary depending on the type of dental implant used.

Furthermore, the fastening area B may be configured in the shape of a ring around the piece being processed 1, as shown in FIGS. 1a-1g. In this way, the dental piece being processed 1 may be firmly clamped in the holder 3 and prevents the piece being processed 1 from slipping during processing.

In a further embodiment, the piece being processed 1 may have a pre-milled inner channel 9. In addition, the piece being processed 1 may also have several pre-milled inner channels 9.

Preferably, the lateral surface 7 of the processing area B and/or the surface U of the fastening area F is configured to be at least partially circular cylindrical in shape, as shown in the figures. The fastening area F deviates from the circular cylindrical shape at the points, where lateral holding surfaces 4 are located on the lateral surface of the fastening area F. The lateral holding surfaces 4 may form indentations on the lateral surface. The lateral diameter DF of the fastening area F is larger than the lateral diameter DB of the processing area B. This in turn defines that the fastening area F extends radially along a section of the longitudinal axis X of the piece being processed 1 around the processing area B.

Particularly preferably, the piece being processed 1 has a length of the piece being processed along the longitudinal axis X that extends over the entire length of the piece being processed 1. This means that the dental element, e.g. abutment, ultimately produced from the piece being processed 1 using a processing device 2 may have the total length of the piece being processed 1 as its maximum length. The height of the processing area B therefore corresponds to the length of the piece being processed 1. For smaller dental elements, the piece being processed 1 is shortened by removing or milling away the area below the top surface 5 of the processing area B using the processing device 2. An example of a dental element produced from the piece being processed 2 is shown in FIGS. 4a and 4b. In this example, an angled abutment is depicted, into which an angled thread has been milled. This is possible due to the processing of the piece being processed 1 along the longitudinal axis X in the processing device 2. In addition, there is visible in FIGS. 4a and 4b that a considerable area of the processing area B has been removed to produce the abutment. In addition, the abutment is still connected to the fixing area F via the ridges depicted, which may be easily separated from the abutment.

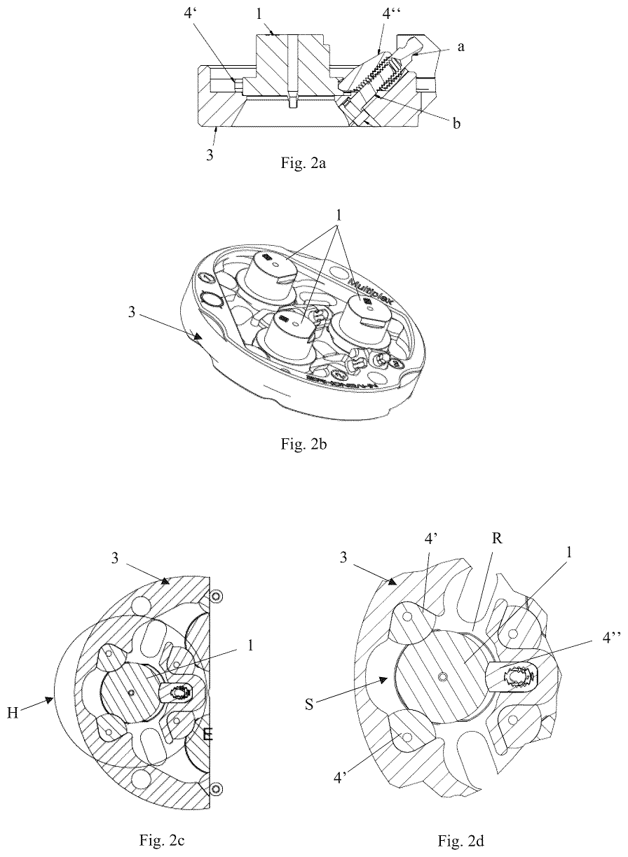

In FIGS. 2a and 2b there is shown a holder 3 according to the invention, and in FIGS. 2c and 2d there are shown detailed sections of the holder 3. The holder 3 makes it possible to hold a dental piece being processed 1 by having a holding area H for the dental piece being processed 1. A clamping device S is formed in the holding area H, to which the fastening area F of the piece being processed 1 may be clamped.

Preferably, the clamping device S comprises at least one clamping element 4′. The clamping element 4′ forms the counterpart to a lateral holding surface 4 formed on the fastening area F, and may engage in the holding surfaces 4 and thus position the piece being processed 1 within the holder 3.

Particularly preferably, the clamping device S also comprises a holding ring R. The holding ring R makes it possible for the piece being processed 1 to be clamped precisely and with low vibration by clamping the fastening area F. Furthermore, the clamping device S may comprise at least one clamping element 4″ that may move in two axes. In this way, the piece being processed 1 may be clamped even more precisely on the holder 3. In addition, the piece being processed 1 may thus also be reproducibly clamped, i.e. even if the piece being processed 1 is removed from the holder 3 during processing in the processing device 2 and then reintroduced into this for further processing, the piece being processed 1 may be fixed again in exactly the same position on the holder 3 with the aid of the movable clamping element 4″ and the lateral holding surfaces 4 in order to enable further processing. The clamping mechanism according to the invention, which is made possible by the clamping device S, thus allows clearly defined clamping of the blanks 1 with maximum clamping and repeat accuracy. In this way, the pieces being processed 1 may also be clamped and unclamped several times in order to carry out any post-processing. In addition, the clamping device S enables a very simple and safe clamping mechanism.

In the embodiment variants of the holder 3 shown in FIGS. 2a-2d, the holding area H has a clamping device S with two clamping elements 4′ and a movable clamping element 4″ as well as a holding ring R. This results in a three-point clamping system, by means of which the fastening area F of the piece being processed 1 may be clamped very precisely and with low vibration on the holder 3. The lateral holding surfaces 4 formed on the fastening area F make it very easy to orient the piece being processed 1 within the holder 3. As shown in FIG. 2a, the movable clamping element 4″ may comprise two screws a and b, whereby a first screw a preferably comprises an internal and an external thread, whereby a second screw b preferably comprises an external thread, which engages in the internal thread of the first screw a. By turning the first screw a, the blank 1 may be clamped on the holder 3, whereby the blank 1 only moves along one axis, which is perpendicular to the longitudinal axis X. By avoiding movement in another axis, the risk of distortion is reduced. However, the movable clamping element 4″ may also have other embodiments.

Preferably, the holder 3 has more than one holding area H for holding a dental piece being processed 1. For example, the holder 3 in FIG. 2b has three holding areas H, allowing three pieces being processed 1 to be clamped in the holder 3 simultaneously and processed in the processing device 2 one after the other without having to clamp a new piece being processed 1 in the holder 3 each time.

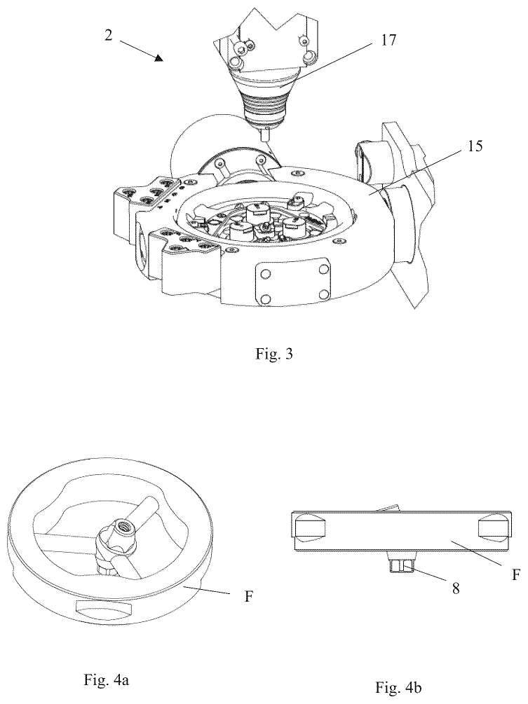

FIG. 3 shows a cut-out of a dental processing device 2 with a housing 15, into which a holder 3 is introduced. The processing device 2 has a processing head 17, which may be a milling cutter, grinder, or the like. Preferably, the holder 3, as shown in FIG. 3, is introduced into a receiving ring for the workpiece of the processing device 2 and preferably abuts against a stop there. The stop may be circular. Furthermore, the holder 3 may be clamped in parallel to the processing axis, i.e. to the longitudinal axis X of the blank 1, to the receiving ring for the workpiece by means of clamping elements and/or fastening elements such as screws.

In a preferred embodiment, the processing device 2 has a calibration device 18, by means of which the position of the at least one piece being processed 1 relative to the holder 3 may be determined. Preferably, the calibration device 18 comprises a 3D calibration probe, by means of which the position of the dental pieces being processed 1 may be precisely measured after clamping within the holder 3. Using a 3D calibration probe, the position of the piece being processed 1 may be determined in all axes, and the position as well as any deviations from the calculated position may be taken into account and compensated for during processing using the processing head 17.

Particularly preferably, the processing device 2 also comprises a control or regulating unit, by means of which the processing head 17, the movement of the holder 3, and/or the calibration device 18 may be controlled or regulated. Using this control or regulating unit, any mispositions of the piece being processed 1, which may be determined by way of the calibration device 18, as described above, may be compensated for by adjusting the processing head 17 to the new position. The calibration device 18 thus transmits the position of the piece being processed 1 to the control or regulating unit. The values detected by the calibration device 18 are stored in the software of the control or regulating unit to enable the execution or adjustment, respectively, of subsequent calculations or calculations already made based on this data.

1. A dental processing piece (1) or blank for producing a dental restoration, in particular an abutment, crown, bridge, or snap-on connection, with
a processing area (B), which may be processed by a dental processing device (2) and which has a cylindrical base body having a longitudinal axis (X), a top surface (5), a base surface (6) and a lateral surface (7), and
a fastening area (F) for fastening the piece being processed (1) to a holder (3) of the processing device (2),
wherein the fastening area (F) is arranged radially around the cylindrical base body of the processing area (B),
wherein the piece being processed (1) may be mounted in the holder (3) with the aid of the fastening area (F) in such a way that it may be processed in parallel to the longitudinal axis (X) in the mounted state.

2. A dental processing piece according to claim 1, wherein the height (h1) of the processing area (B) corresponds to the length of the piece being processed (1),

3. A dental processing piece according to claim 1, wherein the fastening area (B) has at least one lateral holding surface (4), which is configured as an indentation, on which clamping elements (4′) of the holder (3) press in the mounted state.

4. A dental processing piece according to claim 1, wherein the fastening area (B) is formed in an annular shape around a section of the lateral surface (7) of the piece being processed (1).

5. A dental processing piece according to claim 1, wherein the lateral surface (7) of the processing area (B) and/or the surface (U) of the fastening area (F) is configured to be at least partially circular-cylindrical in shape, wherein the lateral diameter (DF) of the fastening area (F) is larger than the lateral diameter (DB) of the processing area (B).

6. A dental processing piece according to claim 1, wherein the piece being processed (1), preferably at the end facing the fastening area (F), has a prefabricated implant connection (8) for fixing the piece being processed (1) to a dental implant.

7. A dental processing piece according to claim 1, wherein the piece being processed (1) has a piece being processed length along the longitudinal axis (X), which extends across the entire length of the piece being processed (1).

8. A holder (3) for holding a dental piece being processed (1), which is configured in particular according to claim 1, having a holding area (H) for the dental piece being processed (1), wherein there is formed a clamping device (S) in the holding area (H), wherein the clamping device (S) clamps around a fastening area (F) formed on the piece being processed (1) radially around the longitudinal axis (X) thereof in the state of the piece being processed (1) being mounted on the holder (3).

9. A holder (3) according to claim 8, wherein the clamping device (S) forms a three-point clamping system comprising at least two clamping elements (4′), at least one movable clamping element (4″) and a holding ring (R), wherein the two clamping elements (4′) as well as the movable clamping element (4″) each engage in a lateral holding surface (4) on the fastening area (F) in the state of the piece being processed (1) being mounted on the holder (3), wherein the holding ring (R) clamps the fastening area (F) in the state of the piece being processed (1) being mounted on the holder (3).

10. A holder (3) according to claim 8, wherein the clamping device (S) comprises at least one clamping element (4′), wherein the clamping element (4′) engages in a lateral holding surface (4) on the fastening area (B) in the state of the piece being processed (1) being mounted on the holder (3).

11. A holder (3) according to claim 8, wherein the clamping device (S) comprises a holding ring (R), wherein the holding ring (R) clamps the fastening area (F) in the state of the piece being processed (1) being mounted on the holder (3).

12. A holder (3) according to claim 8, wherein the clamping device (S) comprises at least one clamping element (4″) movable in two axes, wherein the movable clamping element (4″) engages in a lateral holding surface (4) on the fastening area (B) in the state of the piece being processed (1) being mounted on the holder (3).

13. A holder according to claim 8, wherein the holder (3) has at least two holding areas (H) for respectively holding a dental piece being processed (1).

14. A kit comprising at least one dental processing piece (1) or blank for producing a dental restoration, in particular an abutment, crown, bridge, or snap-on connection and a holder (3) for holding the dental piece being processed (1), wherein:
the dental processing piece (1) or blank is characterized by:
a processing area (B), which may be processed by a dental processing device (2) and which has a cylindrical base body having a longitudinal axis (X), a top surface (5), a base surface (6) and a lateral surface (7), and
a fastening area (F) for fastening the piece being processed (1) to a holder (3) of the processing device (2),
wherein the fastening area (F) is arranged radially around the cylindrical base body of the processing area (B),
wherein the piece being processed (1) may be mounted in the holder (3) with the aid of the fastening area (F) in such a way that it may be processed in parallel to the longitudinal axis (X) in the mounted state,
the holder (3) is characterized by:
having a holding area (H) for the dental piece being processed (1), wherein there is formed a clamping device (S) in the holding area (H), wherein the clamping device (S) clamps around a fastening area (F) formed on the piece being processed (1) radially around the longitudinal axis (X) thereof in the state of the piece being processed (1) being mounted on the holder (3).

15. A dental processing device (2) comprising:
a housing (15),
at least one holder (3) for holding a dental piece being processed (1) connected to the housing (15), in particular movably, holder (3), wherein the holder (3) is characterized by:
having a holding area (H) for the dental piece being processed (1), wherein there is formed a clamping device (S) in the holding area (H), wherein the clamping device (S) clamps around a fastening area (F) formed on the piece being processed (1) radially around the longitudinal axis (X) thereof in the state of the piece being processed (1) being mounted on the holder (3
at least one dental piece being processed (1), which may be fastened or is fastened, respectively, in the holder (3), wherein the dental piece being processed (1) is characterized by:
a processing area (B), which may be processed by a dental processing device (2) and which has a cylindrical base body having a longitudinal axis (X), a top surface (5), a base surface (6) and a lateral surface (7), and
a fastening area (F) for fastening the piece being processed (1) to a holder (3) of the processing device (2),
wherein the fastening area (F) is arranged radially around the cylindrical base body of the processing area (B),
wherein the piece being processed (1) may be mounted in the holder (3) with the aid of the fastening area (F) in such a way that it may be processed in parallel to the longitudinal axis (X) in the mounted state, and
at least one processing head (17), in particular a milling cutter, grinder or the like, for processing the piece being processed (1).

16. A processing device according to claim 15, further comprising a calibration device (18), wherein the position of the at least one piece being processed (1) relative to the holder (3) may be determined by the calibration device (18).

17. A processing device according to claim 15, further comprising a control or regulating unit, by means of which the processing head (17), a movement of the holder (3) and/or the calibration device (18) may be controlled or regulated.
